(19) United States
(12) Patent Application Publication
(10) Pub. No.: US 2010/0012261 A1
(43) Pub. Date: Jan. 21, 2010

(54) ONE-PIECE SELF-EXPIRING LABEL SYSTEM

(76) Inventors: Richard Frederick Reed, Canton, CT (US); Stefan Lawrence Gerum, Winsted, CT (US); James Dobrynski, New Harford, CT (US); Cheryl Doyle, Torrington, CT (US); Suzanne D. Corcoran, West Harford, CT (US)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/483,637

(22) Filed: Jun. 12, 2009

Related U.S. Application Data
(60) Provisional application No. 61/060,844, filed on Jun. 12, 2008.

(51) Int. Cl. B32B 38/00; B32B 33/00

(52) U.S. Cl. 156/227; 428/42.1

(57) ABSTRACT

A self-expiring label system is provided that includes a label, a backing sheet, an adhesive, and a migrating ink pattern. The adhesive removably secures a bottom label surface to a top sheet surface. The migrating ink pattern is on a bottom sheet surface. The lines of weakness define a second portion of the backing sheet around the migrating ink pattern and at least one of the lines is a cut line that defines a starting point for peeling the label away from the backing sheet in a removal direction. The second portion remains adhered to the label by separation from the backing sheet along the lines of weakness upon peeling the label away from the backing sheet in the removal direction when a user simultaneously grasps a top label surface of the first portion and the bottom sheet surface of the second portion through the cut line.

### CROSS REFERENCE TO RELATED APPLICATIONS

This application claims the benefit of U.S. Provisional Application Ser. No. 61/060,844, filed Jun. 12, 2008, the contents of which are incorporated by reference herein.

### BACKGROUND OF THE INVENTION

1. Field of the Invention

The present disclosure is related to a one-piece self-expiring label system and, more particularly, to labels that include a foldable portion having backing containing migrating ink thereon.

2. Description of Related Art

Many self-expiring label systems have a color-changing process that can be easily activated at a specific time. Generally, such labels are useful because the color changing process is easily activated at a specific time and, after a predetermined period of time has passed, the color changing process is completed so that they provide a visual indication of the expiration of the label. Such products have found wide acceptance due primarily to their ease of use.

Generally, the color changing process is activated by overlaying two layers on each other. Prior to activation the layers are kept separate. Typically, the top or exposed substrate is an adhesive label and the bottom substrate has a migrating ink or dye on or within its face. When bonded together, the adhesive from the top label dissolves the dye in the migrating ink, causing it to bleed or diffuse through to the top of the label at a controlled rate. After a predetermined period of time, the dye-colored image is displayed through the front of the top material and can be seen by those viewing the label. Such a color changed label is thus expired, i.e., “self expired” and cannot be used again.

Generally, such known self-expiring labels are initially in two separate pieces, i.e., the top adhesive label and bottom dye or ink containing substrate, and are assembled at the time of issuance, i.e., activation. Because the two substrates are dry materials, they have very long shelf-lives, making these products very commercially practical. However, where there is a high volume of labels issued by, for example, receptionists and security guards the two-part construction proves to be inconvenient and labor intensive. There is a need for a simpler security label that requires less labor to activate.

More recently, one-piece self-expiring labels have been developed as shown and described in U.S. Pat. No. 7,263,037, the entire disclosure of which is incorporated herein by reference. Unfortunately, these prior art one-piece self-expiring labels have proven difficult to use in that the portion of the backing sheet having the migrating ink thereon is often removed from the label, rendering the label unusable. More particularly, it has been determined by the present disclosure that the removal of the label from the backing sheet often results in the portion of the backing sheet having the migrating ink also being removed from the security label.

Accordingly, there is a continuing need for one-piece self-expiring systems and labels that overcome, mitigate, and/or alleviate the aforementioned and other deleterious effects of prior art labels.

### BRIEF SUMMARY OF THE INVENTION

A one-piece self-expiring label system is provided that ensures the desired portion of the backing sheet remains adhered to the label. In this manner, the desired portion of the backing sheet is available to be folded upon the exposed adhesive to activate the migrating ink.

A one-piece self-expiring label system is provided that can be arranged into a sheet or page of labels and, if desired multiple pages of labels can be stacked on top of one another and bound along a common edge to form a book.

A one-piece self-expiring label system is provided that can be arranged into a bound book of labels having a recordation sheet interleaved between each page. In some embodiments, each page of labels is further bound to its corresponding recordation sheet in a removal direction of the label.

In some embodiments, the self-expiring label system includes a label, a backing sheet, an adhesive, a migrating ink pattern, and a plurality of lines of weakness. The label has a top label surface and a bottom label surface, while the backing sheet has a top sheet surface and a bottom sheet surface. The adhesive removably secures the bottom label surface to the top sheet surface. The migrating ink pattern is on the bottom sheet surface. The lines of weakness define a second portion of the backing sheet around the migrating ink pattern and at least one lines is a cut line that defines a starting point for peeling the label away from the backing sheet in a removal direction. The second portion remains adhered to a first portion of the label by separation from the backing sheet along the lines of weakness upon peeling the label away from the backing sheet in the removal direction when a user simultaneously grasps the top label surface of the first portion and the bottom sheet surface of the second portion through the cut line.

In other embodiments, the self-expiring label system includes a label, a backing sheet, an adhesive, a migrating ink pattern, a plurality of lines of weakness, and a cut line. The label has a first portion, while the backing sheet has a second portion. The adhesive removably secures a bottom surface of the label to a top surface of the backing sheet so that the first portion covers the second portion. The migrating ink pattern is on a bottom surface of backing sheet at the second portion. The lines of weakness and cut line define the second portion. The cut line allows a user to simultaneously grasp a top surface of the first portion and the bottom surface of the back sheet at the second portion through the cut line when peeling the at least one label away from the backing sheet in a removal direction. The lines of weakness are configured so that, upon peeling the at least one label away from the backing sheet in the removal direction, the second portion separates from the backing sheet along the plurality of lines of weakness, remains adhered to the first portion, and defines a fold line at the adhesive exposed on the bottom surface of the at least one label. The label is foldable along the fold line so that the migrating ink pattern contacts the adhesive. The migrating ink pattern, the adhesive, and the label are configured so that the migrating ink pattern, upon contact with the adhesive, is visible from the top surface of the label within a predetermined period of time.

A method of using a self-expiring label is also provided. The method includes grasping a top surface of a first portion of a label, the label being adhered to a backing sheet by an adhesive; grasping a bottom surface of a second portion of the backing sheet through a cut line in the backing sheet; peeling the label from the backing sheet while grasping the top and bottom surfaces so that the second portion separates from the backing sheet and remains adhered to the first portion; and folding the first portion having the second portion adhered thereto until the second portion contacts the adhesive.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is a top perspective view of an exemplary embodiment of a self-expiring label system according to the present disclosure;

FIG. 2 is a sectional view of the system of FIG. 1 taken along lines 2-2;

FIG. 3 is a bottom view of the system of FIG. 1 showing an exemplary embodiment of a backing sheet according to the present disclosure;

FIG. 4 is a sectional view of the system of FIG. 1 taken along lines 4-4, illustrating the removal of the backing sheet from the label;

FIG. 5 is a side view of the label of FIG. 4 after the removal of the backing sheet and during a folding process;

FIG. 6 is a side view of the label of FIG. 5 after the folding process;

FIG. 7 is a bottom view of the label of FIG. 5 after the folding process;

FIG. 8 is a bottom plan view of a second exemplary embodiment of a self-expiring label system according to the present disclosure;

FIG. 9 is a top view of another exemplary embodiment of a self-expiring label system according to the present disclosure having a plurality of labels arranged into a page of labels; and

FIG. 10 is a section view of another exemplary embodiment of a self-expiring label system according to the present disclosure having a carbonless carbon material and a recording sheet.

### DETAILED DESCRIPTION OF THE INVENTION

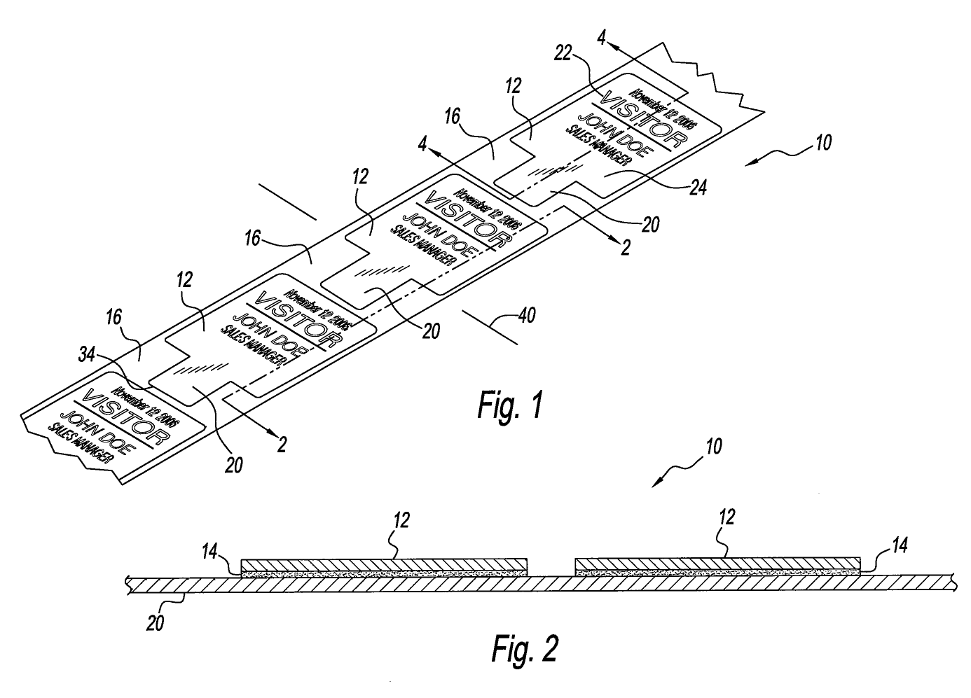

Referring to the drawings and in particular to FIGS. 1 through 4, an exemplary embodiment of a self-expiring label system according to the present disclosure is shown and generally referred to by reference numeral 10.

For purposes of clarity, self-expiring label system 10 is illustrated herein by way of example only in use as a visitor security badge. Of course, it is contemplated by the present disclosure for label 10 to find use in any application where an adhesively applied self-expiring indicator is useable such as, but not limited to, a security badge, a product label, an entrance ticket, a usage pass, and others.

System 10 includes one or more labels 12, an adhesive 14, and a liner or backing sheet 16. Advantageously, system 10 is configured so that upon removal one of the labels 12 from the backing sheet 16, a portion 18 of the backing sheet remains adhered to a portion 20 of that label 12.

The one or more labels 12 are preferably die-cut from a substrate (not shown) into a desired shape, with the remaining portions of the substrate being removed to leave the labels on backing sheet 16 as shown. Labels 12 can include pre-printed indicia 22 on the top surface thereof and/or can include one or more areas 24 configured to receive hand written information on the top surface at the time of use.

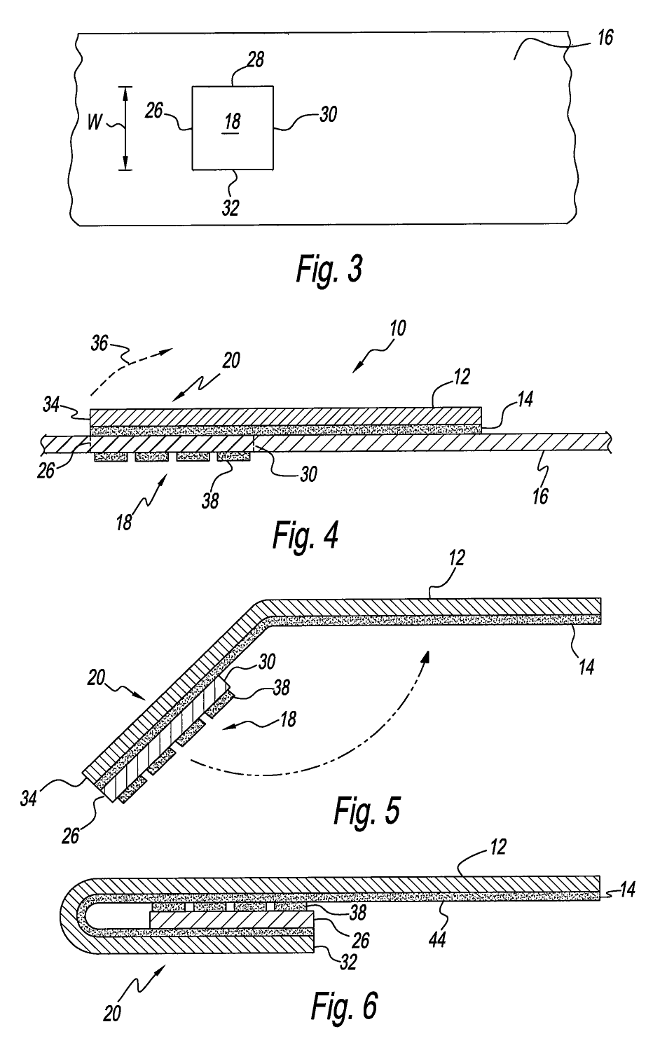

The backing sheet 16 includes portion 18 defined therein by one or more lines of weakness 26, 28, 30, 32 shown in FIG. 3. For reasons discussed in more detail below, at least the line of weakness 26 is a cut line through backing sheet 16. The remaining lines of weakness 28, 30, 32 can be perforation lines, cut lines, scores, and any combinations thereof. In a preferred embodiment, lines of weakness 28, 30, 32 are cut lines with a minimum of ties (not shown) between portion 18 and backing sheet 16.

Line 26 is positioned co-planar to a bottom edge 34 of label 12 as shown in FIG. 4. In this manner, a user can peel label 12 from backing sheet 16 while holding portion 18 at line 26. More particularly, a user can separate backing sheet 16 from itself along cut line 26 when a user places their thumb at the bottom edge 34 of the label. Cut line 26 has a sufficient width (W) to allow the user's thumb to enter the opening formed by cut line 26 so that the user can grasp portions 18, 20 between one finger, such as the thumb, on portion 18 and another finger, such as the forefinger, on portion 20, while peeling the label 12 away from backing sheet 16 in a removal direction 36.

Advantageously, it has been determined by the present disclosure that the combination of grasping portions 18, 20 while peeling the label 12 away from backing sheet 16 in the removal direction 36 mitigates instances of portion 18 remaining on the backing sheet when the label 12 has been removed from the backing sheet.

Backing sheet 16 also includes a migrating ink pattern 38 printed or otherwise disposed on a back side of portion 18. Preferably, migrating ink pattern 38 defines a message or signal to the user such as, but not limited to, the text “expired” or “void”.

Migrating ink pattern 38 contains a component or dye that migrates upon activation or contact with adhesive 14. More particularly, the component or dye in pattern 38 is configured to migrate or diffuse, upon activation or contact with adhesive 14, within a predetermined period of time through adhesive 14 and, in some embodiments through label 12 so as to be visible from the top surface of the label.

For example in some embodiments of system 10, adhesive 14 can be an opaque adhesive layer and label 12 can be a transparent layer. In this embodiment, the component or dye in pattern 38 migrates or diffuses within the predetermined period of time through adhesive 14 so as to be visible from the top surface of the label through the transparent label 12.

In other embodiments of system 10, label 12 can be a porous or semi-porous material such as a paper-based material. In this embodiment, the component or dye in pattern 38 migrates or diffuses within the predetermined period of time through adhesive 14 and label 12 so as to be visible from the top surface of the label.

Of course, any desired color changing technology that can be disposed on portion 18 of the backing sheet 16 and activated by adhesive 14 are contemplated for use with the present disclosure.

Migrating ink pattern 38 and/or the dye therein is inert and immobile when in contact with materials in which the dye is insoluble, e.g., the top of label 12. Thus, migrating ink pattern 38 will not bleed when in contact with the various areas of the front or back of system 10. This permits system 10 containing the labels 12, adhesive layer 14, and backing sheet 16 (with migrating ink pattern 38 thereon) to be rolled up on itself and/or stacked upon itself without resulting in bleeding of the dye into other parts of the system.

However, migrating ink pattern 38 and/or the dye therein is activated and is capable of migrating or diffusing when in contact with adhesive 14. Thus, adhesive 14 can be any desired adhesive sufficient to activate migrating ink pattern 38. In the illustrated embodiment, migrating ink pattern 38 is separated from the activating effects of adhesive 14 until desired. Here, backing sheet 16 provides a protective barrier between the migrating ink pattern 38 and the adhesive 14.

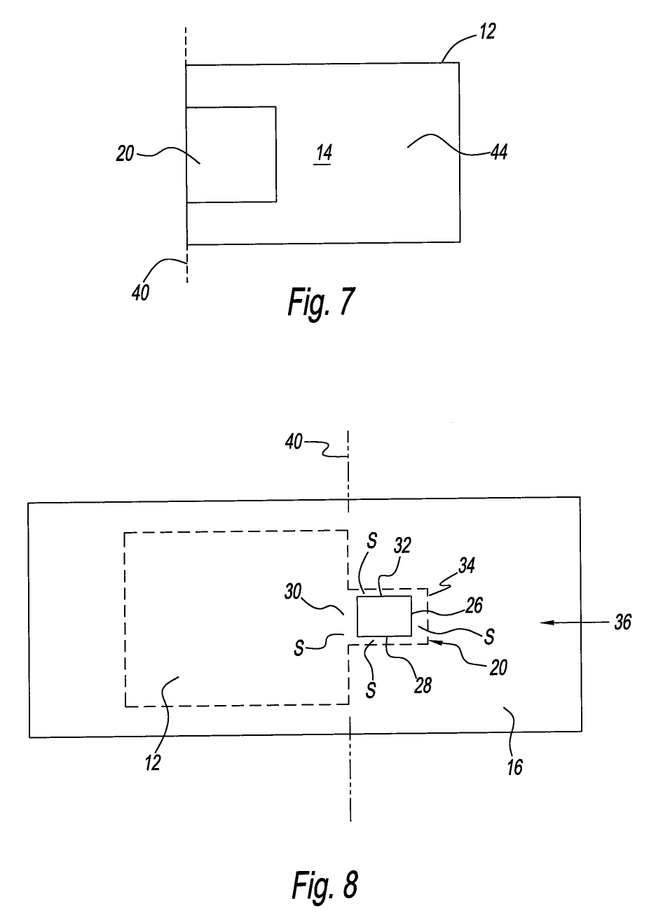

Activation of migrating ink pattern 38 is described with reference to FIGS. 5 through 7. FIG. 5 illustrates label 12 after removal of the label from backing sheet 16, with portion 18 of the backing sheet remaining adhered to portion 20 of label 12. After removal of backing sheet 16, portion 20 of label 12 is folded so that portion 18 of backing sheet 16 contacts adhesive 14 as shown in FIGS. 6 and 7. Thus, label 12 can be folded along a fold line 40 (FIG. 1) to contact migrating ink pattern 38 to adhesive 14. In some embodiments, fold line 40 can also be a line of weakness 42, such as a perforation or score line defined between portion 20 and the main body of label 12.

In the illustrated embodiment, fold line 40 is co-incident to the line of weakness 30 defining portion 18, which is opposite line of weakness 26. Of course, it is contemplated by the present disclosure for label 12 to be folded in any desired manner so that migrating ink pattern 38 contacts adhesive 14.

After folding label 12, a portion 44 of adhesive 14 remains exposed or uncovered by portion 20 of the label. Thus, adhesive portion 44 can be used to secure label 12 to any desired location such as a person's clothing.

It should be recognized that portion 20 of label is illustrated by way of example as having width (W) that is less then the overall width of label 12. However, it is contemplated by the present disclosure for label 12 to have any desired shape sufficient to provide portion 20 of the label over portion 18 of backing sheet 16, where the bottom edge 34 of portion 20 is co-planar to the corresponding cut line 26 of the backing sheet. For example, such as shown in FIG. 8, portion 20 of label 12 can be larger than portion 18 of backing sheet 16.

In this manner, portion 20 is secured by adhesive to backing sheet 16 at a space (S) between the outer perimeter of portion 18 and the outer perimeter of portion 20 to maintain the label portion 20 in a desired position until use.

Portion 20 can be larger than portion 18 in width and/or height so that space (S) is formed on one or more sides of portion 18.

For example, fold line 40 can be co-incident to the line of weakness 30 defining portion 18, which is opposite line of weakness 26 such that no space (S) is present at the portion of the outer perimeter proximate the fold line as shown in FIG. 4. Alternately, fold line 40 can be offset from the line of weakness 30 defining portion 18 such that space (S) is present as shown in FIG. 8.

Also, cut line 26 can be co-planar to the bottom edge 34 of label 12 such that no space (S) is present at the portion of the outer perimeter proximate the cut line as shown in FIG. 4. Alternately, cut line 26 can be slightly inset from bottom edge 34 such that space (S) is present as shown in FIG. 8. Here, a user would initially peel label 12 from backing sheet 16 to disconnect the adhesive at space (S) until cut line 26 was revealed, at which point XXX the user can separate label 12 and backing sheet 16 by placing their thumb into the opening formed by cut line 26 and grasp portions 18, 20 between one finger, such as the thumb, on portion 18 and another finger, such as the forefinger, on portion 20, while peeling the label 12 away from backing sheet 16 in a removal direction 36.

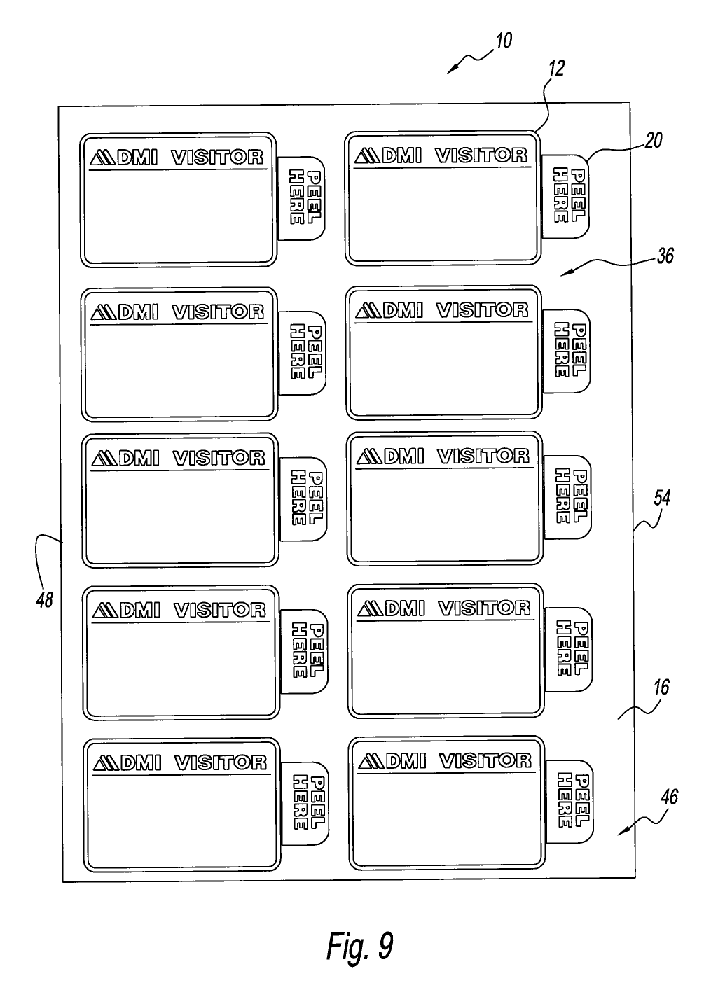

An alternate exemplary embodiment of system 10 is illustrated in FIG. 9. Here, labels 12 are arranged so that backing sheet 16 can be formed as a page 46. For example, page 46 can be a conventional page size such as standard letter size sheets, standard A4 size sheets, or any other desired size.

Furthermore, it has been determined by the present disclosure that configuration of system 10 so that backing sheet 16 is sized as page 46 allows multiple pages 46 to be stacked on top of one another. In some instances, a plurality of pages 46 can be bound to one another along a common edge 48 to form system 10 into a book (not shown).

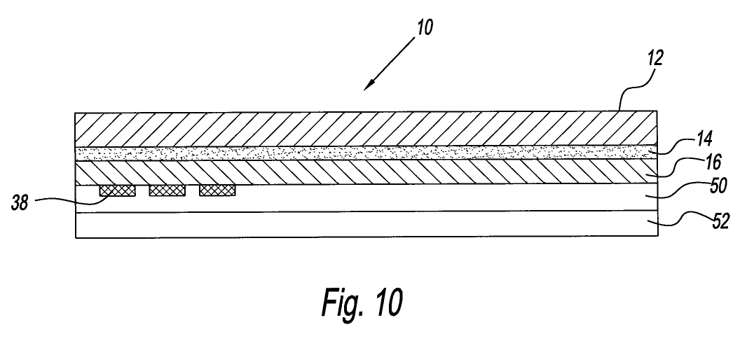

In another embodiment shown in FIG. 10, system 10 can be configured to provide a record of any information hand written on the top surface of label 12, such as information written onto areas 24 (FIG. 1) at the time of use.

In this embodiment, system 10 includes label 12, adhesive 14, backing sheet 16, and pattern 38 in the manner described in detail above. In addition, system 10 includes a transfer material 50 and a recordation sheet 52. Transfer material 50 can be any pressure sensitive material configured so that pressure applied to label 12 is transferred as a visible marking on recordation sheet 50.

For example, transfer material 50 can be carbon paper and recordation sheet 52 can be a simple piece of paper. In another embodiment, transfer material 50 can be carbon-less transfer material applied to the side of backing sheet 16 opposite label 12 in a known manner.

In a particularly preferred embodiment of system 10, backing sheet 16 is formed in the size of a page (FIG. 9) and has transfer material 50 (FIG. 10) thereon. In this manner, the plurality of pages 46 with recordation sheets 52 interleafed therebetween can be bound along common edge 48 to form system 10 into a recordation or log book.

Furthermore and referring again to FIG. 9, it has been determined that in instances where the book includes recordation sheet 52 it may be desired to further secure each page 46 its corresponding recordation sheet 52 along a second common edge 54, which is opposite common edge 48. In this manner, removal of one label 12 from page 46 in the removal direction 36 does not result in the page 46 lifting up from its recordation sheet 52.

Of course, it is also contemplated by the present disclosure for labels 12 to be arranged on page 46 so that the removal direction 36 is opposite to that shown in FIG. 9 so that the binding along common edge 48 prevents backing page 46 from lifting up from its recordation sheet.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A self-expiring label system, comprising:
a label having a top label surface and a bottom label surface;
a backing sheet having a top sheet surface and a bottom sheet surface;
an adhesive removably securing said bottom label surface to said top sheet surface;
a migrating ink pattern on said bottom sheet surface; and
a plurality of lines of weakness in said backing sheet defining a second portion of said backing sheet around said migrating ink pattern, at least one of said plurality of lines of weakness comprising a cut line defining a starting point for peeling said label away from said backing sheet in a removal direction,
said second portion being configured to remain adhered to a first portion of said label by separation from said backing sheet along said plurality of lines of weakness upon peeling said label away from said backing sheet in said removal direction when a user simultaneously grasps said top label surface of said first portion and said bottom sheet surface of said second portion through said cut line.

2. The system of claim 1, wherein said migrating ink pattern, said adhesive, and said label are configured so that said migrating ink pattern, upon contact with said adhesive, is visible from said top surface of said at least one label within a predetermined period of time.

3. The system of claim 1, wherein said cut line is co-planar to a bottom edge of said label.

4. The system of claim 1, wherein said first portion is larger than said second portion.

5. The system of claim 1, further comprising a fold line defined in said label adjacent said first and second portions.

6. The system of claim 1, wherein said migrating ink pattern is inert when in contact said top label surface.

7. The system of claim 6, wherein said label comprises a plurality of labels and said backing sheet is rolled up on itself.

8. The system of claim 1, further comprising a pressure sensitive transfer material and a recordation sheet, said pressure sensitive transfer material being positioned between said bottom sheet surface and said recordation sheet.

9. The system of claim 8, wherein said pressure sensitive transfer material comprises carbon paper or carbon-less transfer material applied to said bottom sheet surface of said backing sheet.

10. The system of claim 8, wherein said label comprises a plurality of labels and said backing sheet comprises a page.

11. The system of claim 10, wherein said page is bound to a plurality of pages along a first common edge to a book.

12. The system of claim 11, wherein said page and said recordation sheet are secured to one another along a second common edge opposite said first common edge.

13. The system of claim 11, wherein said plurality of labels are arranged on said page so that said cut line is proximate said first common edge.

14. A self-expiring label system, comprising:
at least one label having a first portion;
a backing sheet having a second portion;
an adhesive removably securing a bottom surface of said at least one label to a top surface of said backing sheet so that said first portion covers said second portion;
a migrating ink pattern on a bottom surface of backing sheet at said second portion; and
a plurality of lines of weakness and a cut line in said backing sheet defining said second portion, said cut line being configured to allow a user to simultaneously grasp a top surface of said first portion and said bottom surface of said back sheet at said second portion through said cut line when peeling said at least one label away from said backing sheet in a removal direction,
said plurality of lines of weakness being configured so that, upon peeling said at least one label away from said backing sheet in said removal direction, said second portion separates from said backing sheet along said plurality of lines of weakness, remains adhered to said first portion, and defines a fold line at said adhesive exposed on said bottom surface of said at least one label,
said at least one label being foldable along said fold line so that said migrating ink pattern contacts said adhesive, and
said migrating ink pattern, said adhesive, and said at least one label being configured so that said migrating ink pattern, upon contact with said adhesive, is visible from said top surface of said at least one label within a predetermined period of time.

15. The system of claim 14, wherein said cut line is co-planar to a bottom edge of said at least one label.

16. The system of claim 14, wherein said first portion is larger than said second portion.

17. The system of claim 14, wherein said fold line comprises a perforation or score line defined in said at least one label adjacent first and second portions.

18. A method of using a self-expiring label, comprising:
grasping a top surface of a first portion of a label, said label being adhered to a backing sheet by an adhesive;
grasping a bottom surface of a second portion of said backing sheet through a cut line in said backing sheet;
peeling said label from said backing sheet while grasping said top and bottom surfaces so that said second portion separates from said backing sheet and remains adhered to said first portion; and
folding said first portion having said second portion adhered thereto until said second portion contacts said adhesive.

19. The method of claim 18, wherein said peeling comprising peeling said label from said backing sheet in a removal direction, said removal direction being in a direction away from said cut line.
